(19) United States
(12) Patent Application Publication
(10) Pub. No.: US 2020/0134799 A1
(43) Pub. Date: Apr. 30, 2020

(54) IMAGE PROCESSING METHOD AND DEVICE

(71) Applicant: SZ DJI TECHNOLOGY CO., LTD., Shenzhen (CN)

(72) Inventors: Jin XIE, Shenzhen (CN); Dong QIN, Shenzhen (CN)

(21) Appl. No.: 16/727,232

(22) Filed: Dec. 26, 2019

Related U.S. Application Data
(63) Continuation of application No. PCT/CN2017/090989, filed on Jun. 30, 2017.

(51) Int. Cl. G06T 5/50; G06T 1/60

(52) U.S. Cl. CPC G06T 5/50; G06T 3/0093; G06T 1/60

(57) ABSTRACT

An image processing method includes reading first image data from a memory, storing the first image data in a line buffer, processing the first image data to generate a first partial image, writing the first partial image into the memory, reading second image data from the memory, storing the second image data in the line buffer, processing the second image data to generate a second partial image, reading the first partial image from the memory, and splicing the first and the second partial images to obtain an output image. The first image data and the second image data correspond to a same original image having L rows and K columns of pixels. The first image data includes L rows and M columns of pixel data, and the second image data includes L rows and N columns of pixel data. K is larger than or equal to M plus N.

### CROSS-REFERENCE TO RELATED APPLICATION

This application is a continuation of International Application No. PCT/CN2017/090989, filed on Jun. 30, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of image processing, and in particular to a method and image processing apparatus.

### BACKGROUND

A field programmable gate array (FPGA), an application specific integrated circuit (ASIC), and the like, are used for data processing, and particular for image processing. Currently, a power consumption and an area of the FPGA or ASIC are mainly determined by the power consumption and the area of a random access memory (RAM) inside the FPGA or ASIC. The area refer to chip resources of the FPGA or ASIC that include logic resources and input/output (I/O) resources.

In the conventional technologies, the RAM, especially a static random access memory (SRAM), inside the FPGA or ASIC is generally used as a line buffer. In image processing, image data (generally involving hundreds of lines of image data) is stored in the line buffer by lines, such that a lot of powers and most of the area of the SRAM are consumed.

### SUMMARY

In accordance with the disclosure, there is provided an image processing method including reading first image data from a memory, storing the first image data in a line buffer, processing the first image data to generate a first partial image, writing the first partial image into the memory, reading second image data from the memory, storing the second image data in the line buffer, processing the second image data to generate a second partial image, reading the first partial image from the memory, and splicing the first and the second partial images to obtain an output image. The first image data and the second image data correspond to a same original image having L rows and K columns of pixels. The first image data includes L rows and M columns of pixel data, and the second image data includes L rows and N columns of pixel data. K is larger than or equal to M plus N.

In accordance with the disclosure, there is also provided an image processing apparatus including an input circuit, a line buffer, and a processing circuit. The input circuit is configured to read first image data from a memory and store the first data in the line buffer. The first image data includes L rows and M columns of pixel data. The processing circuit is configured to process the first image data to generate a first partial image and write the first partial image into the memory. The input circuit is further configured to read second image data from the memory and store the second image data in the line buffer. The second image data includes L rows and N columns of pixel data. The first image data and the second image data correspond to a same original image having L rows and K columns of pixels. K is larger than or equal to M plus N. The processing circuit is further configured to process the second image data to generate a second partial image. The input circuit is further configured to read the first partial image from the memory. The processing circuit is further configured to splice the first partial image and the second partial image to obtain an output image.

### BRIEF DESCRIPTION OF THE DRAWINGS

FIG. 1 schematically shows a flow of an image processing method.

FIG. 2 is a schematic flow chart of an image processing method consistent with embodiments of the disclosure.

FIG. 3 is a schematic diagram of an image processing apparatus consistent with embodiments of the disclosure.

FIG. 4 schematically shows a flow of another image processing method consistent with embodiments of the disclosure.

FIG. 5 is a schematic diagram showing an image processing method consistent with embodiments of the disclosure.

### DETAILED DESCRIPTION OF THE EMBODIMENTS

Hereinafter, technical solutions of the present disclosure will be described with reference to the drawings. Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure.

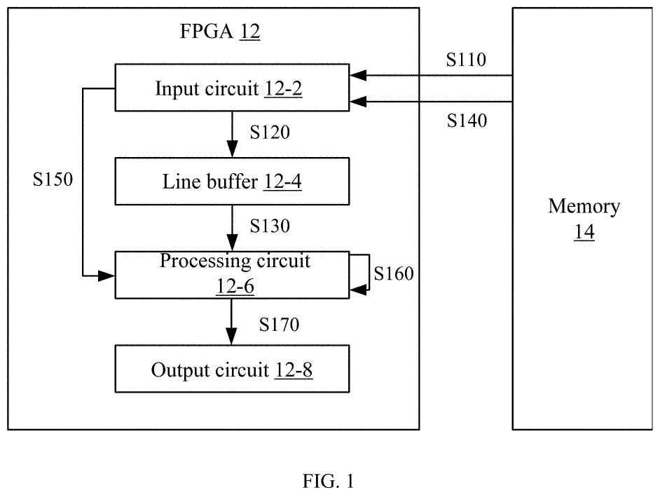

An image processing process can include, but is not limited to, a distortion correction, an image crop, an image rotation, a linear transformation, an image matching, a contour filling, an aberration correction, and/or the like. FIG. 1 schematically shows a flow of an example image processing image processing method. The method in FIG. 1 can be implemented by a field programmable gate array (FPGA) 12 with a memory 14. The FPGA 12 includes an input circuit 12-2, a line buffer 12-4, a processing circuit 12-6, and an output circuit 12-8.

As shown in FIG. 1, at S110, the input circuit 12-2 reads image data of an original image from the memory 14. An original image includes L rows and K columns of pixels, and the image data of the original image includes data of the L rows and K columns of pixels. In some embodiments, the original image can include a region of interest (ROI) of an image to be processed.

At S120, the image data of the original image is written into the line buffer 12-4. The line buffer 12-4 can be, for example, a static random access memory (SRAM).

At S130, the image data of the original image is transmitted from the line buffer 12-4 to the processing circuit 12-6.

At S140, the input circuit 12-2 reads parameters for image processing from the memory 14. For example, when the image processing includes the distortion correction, the parameters may include mesh information or the like.

At S150, the parameters are transmitted to the processing circuit 12-6. For example, the parameters can include the mesh information.

At S160, the processing circuit 12-6 processes the image data of the original image according to the parameters to obtain an output image. For example, when the image processing includes the distortion correction, the image data of the original image may include distortion coordinates, and the parameters may include the mesh information which includes corresponding corrected display coordinates. The processing circuit 12-6 can process the pixels of the original image according to the distortion coordinates and the corrected display coordinates, to obtain a corrected image (i.e., the output image).

At S170, the processing circuit 12-6 transmits the output image to output circuit 12-8. The output circuit 12-8 can output the output image to a subsequent device.

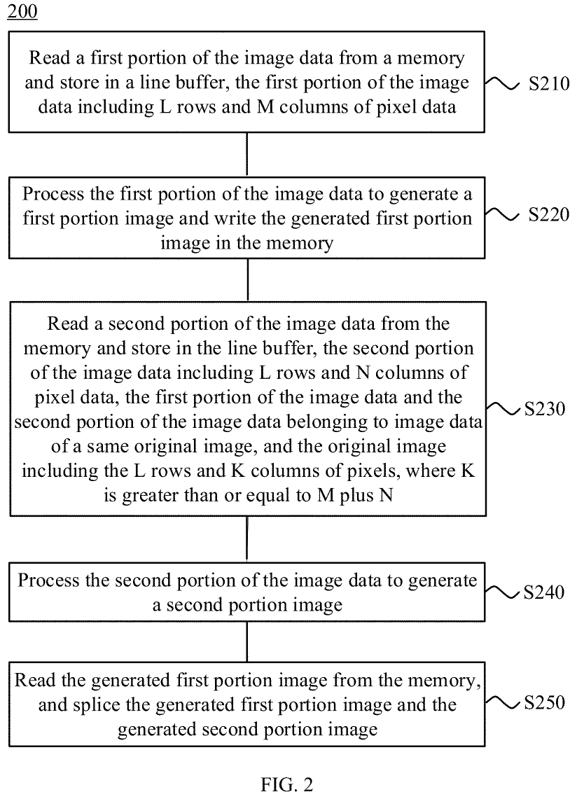

FIG. 2 is a schematic flow chart of an example image processing method 200 consistent with the disclosure. The method 200 can be implemented by an image processing device, such as an FPGA or an ASIC.

As shown in FIG. 2, at S210, a first portion of the image data (first image data) is read from a memory and stored in a line buffer. The first portion of the image data can include L rows and M columns of pixel data. L and M are integers equal to or larger than one.

At S220, the first portion of the image data is processed to generate a first partial image and the generated first partial image is written into the memory.

At S230, a second portion of the image data (second image data) is read from the memory and stored in the line buffer. The second portion of the image data can include L rows and N columns of pixel data. N is an integer equal to or larger than one. The first portion of the image data and the second portion of the image data belong to image data of a same original image. The original image includes the L rows and K columns of pixels, where K is an integer greater than or equal to M plus N.

At S240, the second portion of the image data is processed to generate a second partial image.

At 250, the generated first partial image is read from the memory, and the generated first partial image and the generated second partial image are spliced.

Consistent with the disclosure, the image processing method can process some columns of the pixel data in the original image to obtain a partial image at a time, and then splice the obtained two partial images. As such, storing only some columns of pixel data in the line buffer at a time can reduce the requirement on the area of the line buffer, thereby reducing the power consumption.

Hereinafter, take performing the distortion correction on the first portion of the image data and the second portion of the image data as an example of processing the first portion of the image data and the second portion of the image data as, and the image processing method will be described in detail. The image processing method can be also applicable to image processing processes, such as the distortion correction, the image crop, the image rotation, the linear transformation, the image matching, the contour filling, the aberration correction, and/or the like, which are not limited herein.

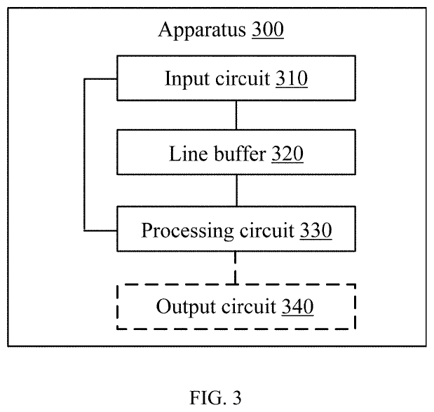

FIG. 3 is a schematic diagram of an example image processing apparatus 300 consistent with the disclosure. The image processing apparatus 300 may include an FPGA or an ASIC. As shown in FIG. 3, the apparatus 300 includes an input circuit 310, a line buffer 320, and a processing circuit 330. In some embodiments, the line buffer 320 can include a random access memory (RAM), such as, a SRAM.

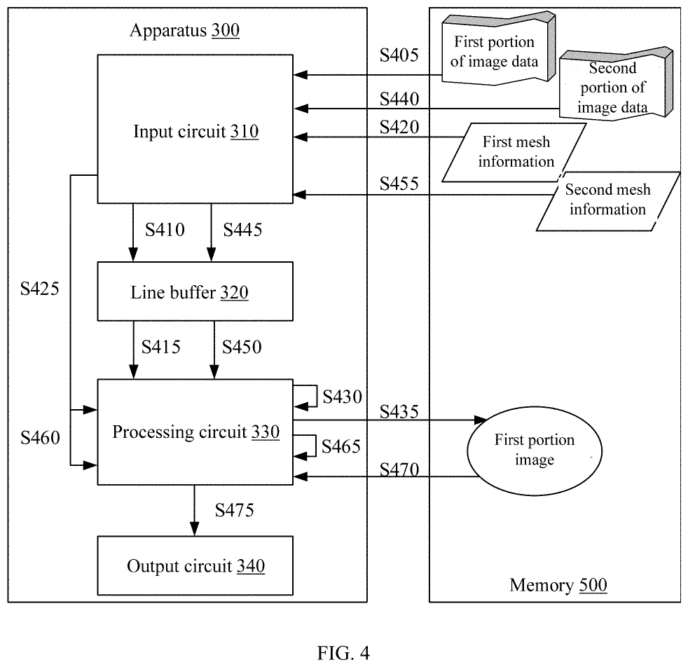

FIG. 4 schematically shows a flow of an example image processing method 400 consistent with the disclosure. The image processing method 400 in FIG. 4 can be implemented by the apparatus 300 in FIG. 3.

As shown in FIG. 4, at 405, the input circuit 310 reads the first portion of the image data from a memory 500. The first portion of the image data can include the L rows and M columns of pixel data. The first portion of the image data belongs to the image data of the original image to be processed, and the original image includes the L rows and K columns of pixels, where K is greater than M. That is, the input circuit 310 can read some columns of pixel data from the memory 500.

At S410, the first portion of the image data is stored in the line buffer 320. Compared with reading and storing the image data of the entire original image having the L rows and K columns of pixels, storing only the first portion of the image data in the line buffer 320 can save the area of the line buffer.

At S415, the first portion of the image data is transmitted from the line buffer 320 to the processing circuit 330.

At S420, the input circuit 310 reads first parameters for image processing from the memory 500. For example, when the image processing includes the distortion correction, the first parameters may include first mesh information or the like.

At S425, the first parameters are transmitted to the processing circuit 330. For example, the parameters can include the first mesh information.

At S430, the processing circuit 300 processes the first portion of the image data according to the first parameters to obtain the first partial image. For example, when the image processing includes the distortion correction, the first portion of the image data may include the distortion coordinates, and the first parameters may include the first mesh information that includes the corresponding corrected display coordinates. The processing circuit 300 can process the first portion of the image data according to the distortion coordinates and the corrected display coordinates, to obtain the first partial image.

The processes at S420 to S430 correspond to the process at S220 (i.e., processing the first portion of the image data to generate the first partial image). For example, the first mesh information can be read from the memory 500, and the first partial image can be generated according to the first mesh information and the first portion of the image data.

At S435, the generated first partial image is written into the memory 500.

At S440, the input circuit 310 reads the second portion of the image data from the memory 500. The second portion of the image data includes the L rows and N columns of pixel data. The second portion of the image data belongs to the image data of the original image to be processed. The original image includes the L rows and K columns of pixels, where K is greater than N and greater than or equal to M plus N. That is, the input circuit 310 can read some other columns of pixel data from the memory 500.

At S445, the second portion of the image data is stored in the line buffer 320. Compared with reading and storing the image data of the entire original image having the L rows and K columns of pixels, storing only the second portion of the image data in the line buffer 320 can save the area of the line buffer.

At S450, the second portion of the image data is transmitted from the line buffer 320 to the processing circuit 330.

At S455, the input circuit 310 reads the second parameters for image processing from the memory 500. For example, when the image processing includes the distortion correction, the second parameters may include second mesh information or the like.

At S460, the second parameters are transmitted to the processing circuit 330. For example, the second parameters can include the second mesh information. In some embodiments, if the first mesh information read at S420 can be used to process the second portion of the image data, the process at S455 and S460 can be omitted. In the subsequent processes, the first mesh information can be used as the second mesh information.

At S465, the processing circuit 330 processes the second portion of the image data according to the second parameters to obtain the second partial image. The processing processes at S465 are similar to the processes on the first portion of the image data at S430, and detailed description thereof is omitted herein.

The processes at S455 to S465 correspond to the processes at S230 (i.e., processing the second portion of the image data to generate the second partial image). For example, the second mesh information can be read from the memory 500, and the second partial image can be generated according to the second mesh information and the second portion of the image data.

At S470, the processing circuit 330 reads the generated first partial image from the memory 500 via the input circuit 310, and splice the generated first partial image and the generated second partial image.

In some embodiments, the process at S470 (i.e., reading the generated first partial image from the memory 500) can be implemented after the completion of the process at S465. In some other embodiments, in order to shorten the time of the entire processing of the method, the process at S470 and the process at S465 can be implemented at the same time, i.e., the generated first partial image can be read from the memory 500 while implementing the process at S465, which is not limited herein.

Referring again to FIG. 3, the apparatus 300 further includes an output circuit 340. Referring again to FIG. 4, at S475, the processing circuit 330 transmits the spliced output image to the output circuit 340. The output circuit 340 can output the output image to the subsequent device. The output image can be an image obtained by splicing the first partial image and the second partial image, or can be an image after other partial images are spliced together with the first partial image and the second partial image, which is not limited herein.

In some embodiments, the original image can be divided into two portions for processing, i.e., K is equal to M plus N, and the image obtained by splicing the first partial image and the second partial image is the distortion corrected image corresponding to the original image. In some embodiments, M can be equal to N.

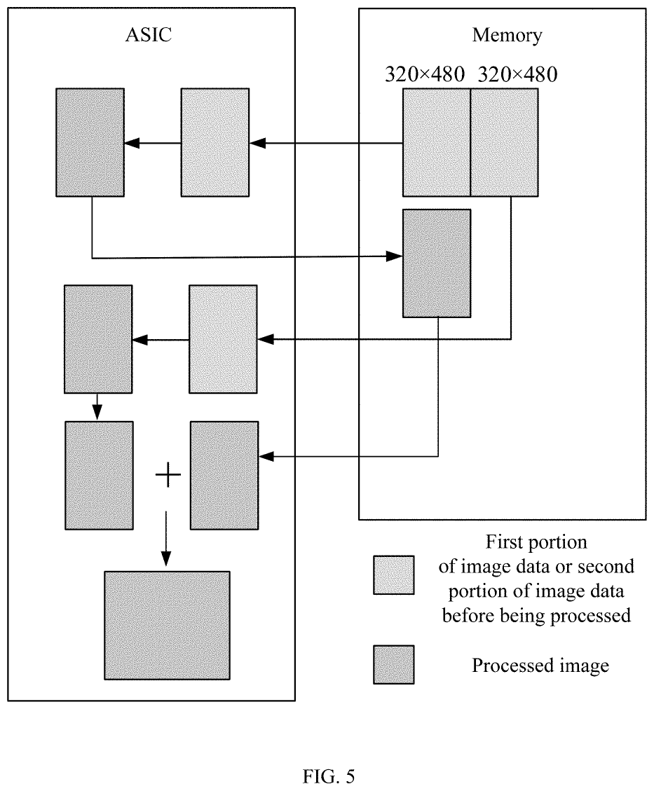

For example, the original image can have a resolution of 640×480. That is, the original image includes 480 rows and 640 columns of pixels. FIG. 5 is a schematic diagram showing an example image processing method consistent with the disclosure. As shown in FIG. 5, the original image is divided into two portions having a resolution of 320×480 for processing, and hence, the first portion of the image data and the second portion of the image data include 480 rows and 320 columns of pixel data. The ASIC can be configured to read the first portion of the image data to obtain the first partial image and store the first partial image in the memory. The ASIC can be configured to read the second portion of the image data to obtain the second partial image. The ASIC can be further configured to read the stored first partial image from the memory, and splice the first partial image and the second partial image.

In some embodiments, the original image can be divided into a plurality of portions (e.g., four portions) for processing. The first portion of the image data, the second portion of the image data, a third portion of the image data (third image data), and a fourth portion of the image data (fourth image data) can each include 480 rows and 160 columns of pixel data, and can correspond to the generated first partial image, the generated second partial image, a generated third partial image, and a generated fourth partial image, respectively. The processing circuit 330 can sequentially splice the first partial image to the fourth partial image together to obtain the distortion corrected image corresponding to the original image.

In some embodiments, the number of columns included in each portion of the image data can be equal. In some other embodiments, the number of columns included in any two portions of the image data can be equal or unequal. The number of columns included in each portion of the image data may be determined by a software or a hardware external to the apparatus 300 and notified to the apparatus 300, which is not limited herein.

Referring again to FIG. 4, in some embodiments, at S475, the output circuit 340 can output the spliced distortion corrected image after all the lines have been processed and spliced. In some other embodiments, the output circuit 340 can output a spliced line, after each line is processed and spliced, i.e., perform a line-by-line output, which is not limited herein.

The present disclosure further provides a computer readable storage medium. The computer readable storage medium can store instructions, when executed by a computer, causing the computer to implement the image processing method consistent with the disclosure, for example, the methods 200 and 400 described above.

The present disclosure further provides a computer program product. The computer program product can comprise instructions, when executed by a computer, causing the computer to implement the image processing method consistent with the disclosure, for example, the methods 200 and 400 described above.

The example embodiments described above can be implemented in a computer software, electronic hardware, firmware, or a combination thereof. Some or all processes of a method consistent with the disclosure can be implemented in the form of computer program, which can be sold or used as a standalone product. The computer program can include one or more computer instructions, when executed by a computer device, can cause the computer device to implement some or all processes or functions of a method consistent with the disclosure, such as one of the example methods described above. The computer device can include a general purpose computer, a special purpose computer, a computer network, or other programmable device. The computer instructions can be stored in a computer readable storage medium or transmitted from one computer readable storage medium to another computer readable storage medium. For example, the computer instructions may be transmitted from a website, computer, server, or data center to another website, computer, server, or data center via a wired connection (e.g., a coaxial cable, fiber optic cable, digital subscriber line (DSL), or the like) or a wireless connection (e.g., an infrared connection, WiFi, microwave connection, or the like). The computer readable storage medium can include any medium that can be accessed by a computer or a data storage device integrated one or more mediums, such as a server, data center, or the like. The medium can include a magnetic medium, for example, a floppy disk, a hard disk, a magnetic tape, or the like, an optical medium, for example, a high-density digital video disc (DVD) or the like, a semiconductor medium, for example, a solid state hard disk (SSD) or the like.

As used herein, the terms “certain embodiment,” “an embodiment,” “some embodiments,” “an example,” “certain example,” “some examples,” or the like, refer to that the specific features, structures, materials, or characteristics described in connection with the embodiments or examples are included in at least one embodiment or example of the disclosure. The illustrative representations of the above terms are not necessarily referring to the same embodiments or examples. Furthermore, the specific features, structures, materials, or characteristics described may be combined in a suitable manner in any one or more embodiments or examples.

The reference numerals of the processes of the example methods described above are not intended to indicate an implementation order and limit the implementation process of the present disclosure. The implementation order of the various processes should be determined according to their functions and internal logics.

Herein, “B corresponding to A” refers to that B is associated with A, and B can be determined according to A. However, determining B according to A is not intended to indicate that B is determined only based on A, but B can also be determined according to A and/or other information.

The terms “and/or” is merely for illustrating that the associated objects have three relationships. For example, A and/or B may represent one of three situations, i.e., A alone, both A and B, and B alone. In addition, the character “/” between two items generally indicates an “or” relationship between the associated two items.

Those of ordinary skill in the art will appreciate that the exemplary elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of exemplary systems, devices, and units may be omitted and references can be made to the descriptions of the exemplary methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

It is intended that the disclosed embodiments be considered as exemplary only and not to limit the scope of the disclosure. Changes, modifications, alterations, and variations of the above-described embodiments may be made by those skilled in the art within the scope of the disclosure. The scope of the invention is defined by the following claims.

What is claimed is:

1. An image processing method comprising:
reading first image data from a memory and storing the first image data in a line buffer, the first image data including L rows and M columns of pixel data;
processing the first image data to generate a first partial image;
writing the first partial image into the memory;
reading second image data from the memory and storing the second image data in the line buffer, the second image data including L rows and N columns of pixel data, the first image data and the second image data corresponding to a same original image having L rows and K columns of pixels, and K being larger than or equal to M plus N;
processing the second image data to generate a second partial image;
reading the first partial image from the memory; and
splicing the first partial image and the second partial image to obtain an output image.

2. The method of claim 1, wherein processing the first image data include performing distortion correction on the first image data.

3. The method of claim 1, wherein processing the first image data include:
reading mesh information from the memory; and
generating the first partial image according to the mesh information and the first image data.

4. The method of claim 1, wherein processing the second image data include performing distortion correction on the second image data.

5. The method of claim 1, wherein processing the second image data include:
reading mesh information from the memory; and
generating the second partial image according to the mesh information and the second image data.

6. The method of claim 1, wherein K equals M plus N.

7. The method of claim 1, wherein M equals N.

8. An image processing apparatus comprising:
an input circuit;
a line buffer; and
a processing circuit;
wherein:
the input circuit is configured to read first image data from a memory and store the first data in the line buffer, the first image data including L rows and M columns of pixel data;
the processing circuit is configured to process the first image data to generate a first partial image and write the first partial image into the memory;
the input circuit is further configured to read second image data from the memory and store the second image data in the line buffer, the second image data including L rows and N columns of pixel data, the first image data and the second image data corresponding to a same original image having L rows and K columns of pixels, and K being larger than or equal to M plus N;
the processing circuit is further configured to process the second image data to generate a second partial image;
the input circuit is further configured to read the first partial image from the memory; and
the processing circuit is further configured to splice the first partial image and the second partial image to obtain an output image.

9. The apparatus of claim 8, wherein the input circuit is further configured to send the first partial image to the processing circuit.

10. The apparatus of claim 8, wherein the processing circuit is further configured to perform distortion correction on the first image data.

11. The apparatus of claim 10, wherein the processing circuit is further configured to:
read mesh information from the memory; and
generate the first partial image according to the mesh information and the first image data.

12. The apparatus of claim 8, wherein the processing circuit is further configured to perform distortion correction on the second image data.

13. The apparatus of claim 12, wherein the processing circuit is further configured to:
read mesh information from the memory; and
generate the second partial image according to the mesh information and the the image data.

14. The apparatus of claim 8, wherein K equals M plus N.

15. The apparatus of claim 8, wherein M equals N.

16. The apparatus of claim 8, wherein the apparatus includes at least one of a field programmable gate array (FPGA) or an application specific integrated circuit (ASIC).

17. The apparatus of claim 8, wherein the line buffer includes a static random access memory (SRAM).
